(19) United States
(12) Patent Application Publication
(10) Pub. No.: US 2023/0275954 A1
(43) Pub. Date: Aug. 31, 2023

(54) REMOTE BROWSER SESSION PRESENTATION WITH LOCAL BROWSER TABS

(71) Applicant: Citrix Systems, Inc., Fort Lauderdale, FL (US)

(72) Inventors: Manbinder Pal Singh, Coral Springs, FL (US); Jason Willoughby, Fort Lauderdale, FL (US); Shreif Abdallah, Fort Lauderdale, FL (US); Muhammad Dawood, High Wycombe (GB)

(21) Appl. No.: 17/592,240

(22) Filed: Feb. 3, 2022

(51) Int. Cl. H04L 67/02

(52) U.S. Cl. CPC H04L 67/02

(57) ABSTRACT

Systems and methods for supporting multiple local browser tabs and windows during a remote browser session are described. A remote browser session may be, in some examples, a remote session accessed in a local browser tab with inputs to the remote session launching web pages and applications on a server rather than locally on a device. In some remote browser session experiences, further interactions with the launched web pages and applications may be limited to being within the local browser tab. The user can instead utilize functionality and methods where applications and browser windows can be started in or moved to individual tabs or windows of the local browser. Then those different tabs and windows may be selected to switch between applications and/or web sites that are running in a shared remote session on a server saving server resources.

### FIELD

Aspects described herein generally relate to computer networking, remote computer access, virtualization, and hardware and software related thereto. More specifically, one or more aspects described herein provide for techniques of remote browser session presentation with local browser tabs.

### BACKGROUND

Virtual computing provides many benefits, in part, through the leveraging of processing capacity of server computing systems. Virtual or remote computing environments may provide central servers to host applications and other resources. These applications and other resources may then be provided to remote users accessing these resources from devices remotely over a network (e.g., the internet). The applications do not need to be installed on the devices as the configuration and data for the applications are on the remote computing system. Inputs such as keystrokes and mouse clicks may be sent to the remote computing system and screen updates may be returned. However, some tasks performed in virtual computing arrangements may behave differently than what a user is accustomed to when working locally.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

A remote browser session may be, in some examples, a client device running a remote session in a local browser tab. The remote session including a remote browser to launch web pages and applications on a server rather than locally on a client device. Without the techniques and methods described herein, in some remote browser session experiences, interactions with the web pages and applications may be limited to within the local browser tab. The web pages and/or applications may be running on different tabs in a browser within the local browser tab, but these tabs cannot be moved to the top-level of the local browser or to their own window. Without the techniques and methods described herein, a clientless receiver like an application switcher (app switcher) may be used to run inside the browser to switch between the applications and/or the web pages. Applications and/or web pages may be selected for switching via a taskbar or grid-view list. However, use of an app switcher is still limited to the confines of a single local browser tab.

To overcome these limitations, and to overcome other limitations that will be apparent upon reading and understanding the present specification, aspects described herein are directed towards techniques of supporting multiple browser tabs and windows during remote sessions. In some implementations, a single shared remote session may be spread over a plurality of top-level local web browser window tabs and windows. Support of multiple browser tabs and windows during remote sessions may present an experience that may be more in line with expected interactions with local web browser tabs and windows. For example, switching between the web sites and/or different applications accessed remotely may be accomplished by clicking on local browser tabs present at the top of the local web browser. In another example, dragging and dropping tabs that are displaying the remote web sites and/or remote applications is similar to drag and drop functionality of local web browser tabs. In other words, a tab drag and dropped to a different open local browser window is moved to a tab position of the different open local browser window. A tab drag and dropped outside the local web browser window opens in its own local web browser window and so forth. In addition, having a single shared session for the multiple apps or web browser tabs spread across the tabs and windows reduces resources required on a server executing the remote session as only a single remote session needs to be executed rather than a separate remote session for each tab and/or window.

In some examples, a computing device may access a remote computing session with use of a web browser executable on the computing device, the remote computing session configured to provide the computing device with access to applications hosted by a remote computing device. The computing device may intercept a request to launch an application hosted by the remote computing device. The computing device may determine an identifier for a tab of the web browser on which to render at least one image of the application indicated by the intercepted request. The computing device may receive the image of the application from the remote computing device. The computing device may render the at least one image of the application within the tab of the web browser based on the determined identifier. The plurality of applications or web pages may be hosted by the remote computing device in a plurality of web browser tabs, each associated with a respective identifier for the tab and respective images are displayed on each of the respective web browser tabs associated with respective identifiers. The respective images may be received from a plurality of tabs hosted by the remote computing device and one of the plurality of tabs from the remote computing device is active and another of the plurality of tabs from the remote computing device is inactive. The computing device may intercept inputs from a peripheral input device and redirects them to the remote session. The computing device may use a browser extension to intercept the request to launch the application hosted by the remote computing device. The computing device may use an HTML5 client to intercept the request to launch the application hosted by the remote computing device. The browser native protocol of the web browser may have been extended to enable the sending of the identifier and the request to the remote session.

In some examples, the computing device may further receive, by a native process running on the computing device, the identifier for the tab of the web browser. The computing device may access, by the native process using the request, the remote computing session consequent to receiving the identifier for the tab of the web browser. The computing device may receive, by the native process, the image of the application from the remote computing device. The computing device may send, by the native process, the image of the application to the web browser along with the identifier for the tab of the web browser. The image of the application to the web browser may be received by the native process via a virtual channel.

In some examples, a client process executing on a computing device may monitor requests to launch new remote applications or web pages in a tab of a local web browser. The client process may request to launch a new application or web page in the tab of the local web browser consequent to monitoring. The client process may send a tab identifier associated with the local web browser and the request to a native process operating a remote session. The client process may receive images along with the tab identifier from the native process operating the remote session. The client process may display each of the images on a web browser tab associated with the tab identifier.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative computing system architecture that may be used in accordance with one or more illustrative aspects described herein.

FIG. 4 depicts an illustrative cloud-based system architecture that may be used in accordance with one or more illustrative aspects described herein.

FIG. 5 depicts an illustrative platform architecture that may be used in accordance with one or more illustrative aspects described herein.

FIG. 6 depicts an illustration of a web browser remote session with applications bounded by a local tab.

FIG. 7 depicts an illustration of a web browser remote session with remote browser tabs bounded by a local tab.

FIG. 8 depicts an illustration of the web browser remote session of FIG. 7 with the remote browser tabs no longer bounded by the single local tab.

FIG. 9 depicts a schematic representation of data movement for supporting multiple local browser tabs and windows during remote browser session.

FIG. 10 depicts a flowchart showing an example method for separating multiple local browser tabs and windows for remote content.

FIG. 11 depicts a flowchart showing an example method for interacting with remote session for supporting multiple local browser tabs and windows for remote content.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

Systems and methods described herein are directed towards techniques of supporting multiple local browser tabs and windows during a remote browser session. In some implementations, the need for an app switcher may be eliminated or reduced. If the app switcher is being used to allow for switching between applications within a single tab which is being session shared, this may be no longer needed. The user can instead utilize the functionality herein that applications and browser windows can be started in or moved to individual tabs or windows of the local browser. Then those different tabs and windows may be selected to switch between applications and/or web sites that are running in a shared remote session on a server.

In some implementations, the ability to show and interact with remote applications and/or web pages that are session shared on different local tabs or windows of a local web browser consumes fewer resources on the server side. Otherwise, without the functionality described herein, a different session would have to be launched on the server side for each local tab or window of the local web browser. Thus, the techniques and functionality herein allow for a user experience of multiple tabs and windows at the level of the local web browser while still session sharing to a single session on the remote server.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” and similar terms, is meant to include both direct and indirect mounting, connecting, and coupling.

### Computing Architecture

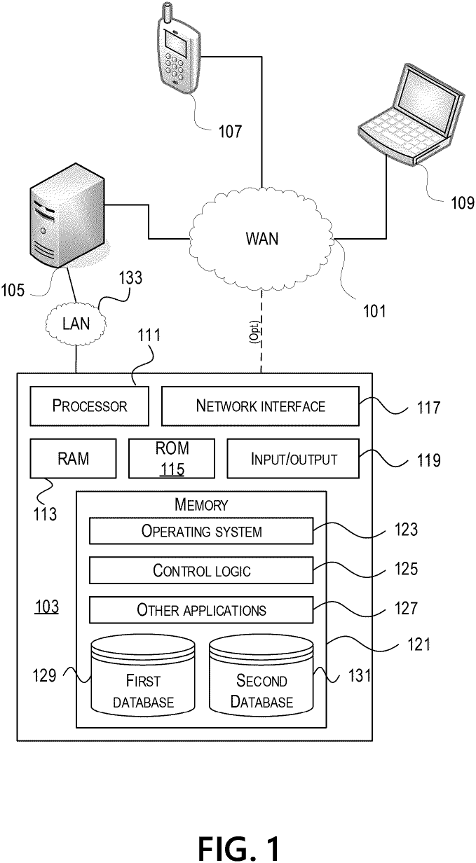

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data-attributable to a single entity–which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. The various methods described herein may comprise an algorithm executed on a computing device. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

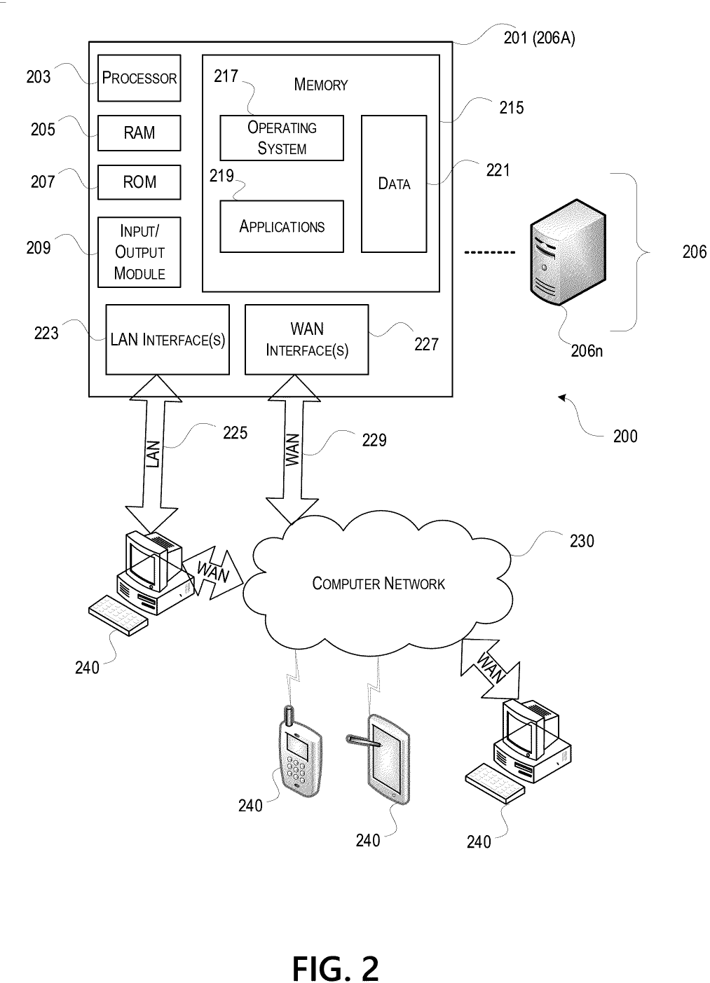

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) and can be configured to provide virtual machines for client access devices. The computing device 201 may have a processor 203 for controlling overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Florida; or the Remote Desktop Protocol (RDP) manufactured by the Microsoft Corporation of Redmond, Washington.

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, iOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 as well as address information associated with an application server 206 hosting an application identified within the enumeration of applications. First server 206a can then present a response to the client’s request using a web interface, and communicate directly with the client 240 to provide the client 240 with access to an identified application. One or more clients 240 and/or one or more servers 206 may transmit data over network 230, e.g., network 101.

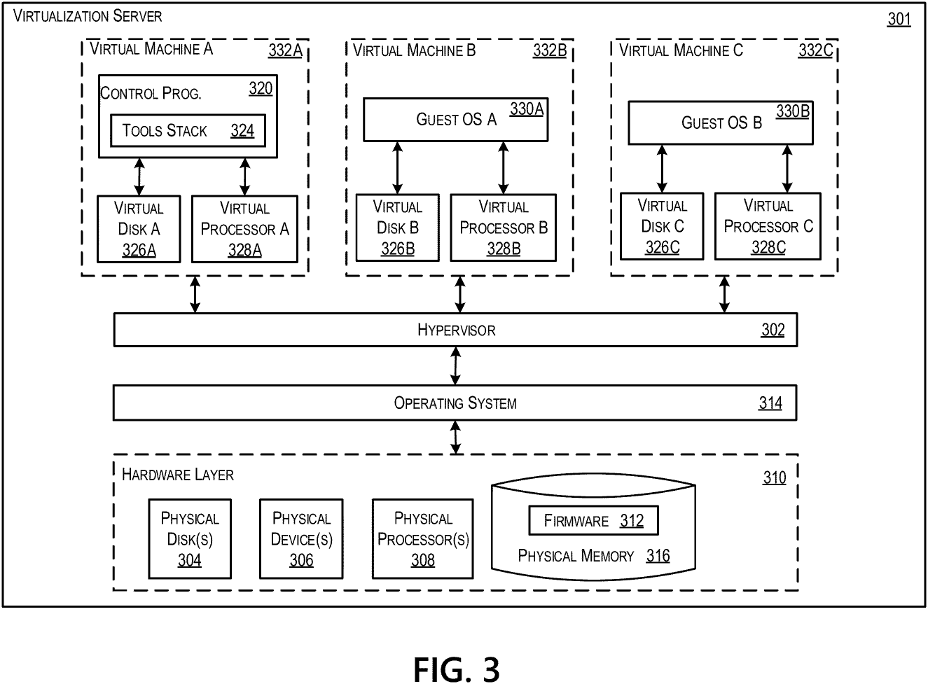

FIG. 3 shows a high-level architecture of an illustrative desktop virtualization system. As shown, the desktop virtualization system may be single-server or multi-server system, or cloud system, including at least one virtualization server 301 configured to provide virtual desktops and/or virtual applications to one or more client access devices 240. As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e.g., many instances of an OS running on a single device). Each application may be executed on a local device, or executed on a remotely located device (e.g., remoted).

A computer device 301 may be configured as a virtualization server in a virtualization environment, for example, a single-server, multi-server, or cloud computing environment. Virtualization server 301 illustrated in FIG. 3 can be deployed as and/or implemented by one or more embodiments of the server 206 illustrated in FIG. 2 or by other known computing devices. Included in virtualization server 301 is a hardware layer that can include one or more physical disks 304, one or more physical devices 306, one or more physical processors 308, and one or more physical memories 316. In some embodiments, firmware 312 can be stored within a memory element in the physical memory 316 and can be executed by one or more of the physical processors 308. Virtualization server 301 may further include an operating system 314 that may be stored in a memory element in the physical memory 316 and executed by one or more of the physical processors 308. Still further, a hypervisor 302 may be stored in a memory element in the physical memory 316 and can be executed by one or more of the physical processors 308.

Executing on one or more of the physical processors 308 may be one or more virtual machines 332A-C (generally 332). Each virtual machine 332 may have a virtual disk 326A-C and a virtual processor 328A-C. In some embodiments, a first virtual machine 332A may execute, using a virtual processor 328A, a control program 320 that includes a tools stack 324. Control program 320 may be referred to as a control virtual machine, Dom0, Domain 0, or other virtual machine used for system administration and/or control. In some embodiments, one or more virtual machines 332B-C can execute, using a virtual processor 328B-C, a guest operating system 330A-B.

Virtualization server 301 may include a hardware layer 310 with one or more pieces of hardware that communicate with the virtualization server 301. In some embodiments, the hardware layer 310 can include one or more physical disks 304, one or more physical devices 306, one or more physical processors 308, and one or more physical memory 316. Physical components 304, 306, 308, and 316 may include, for example, any of the components described above. Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in the hardware layer 310 may include any type of memory. Physical memory 316 may store data, and in some embodiments may store one or more programs, or set of executable instructions. FIG. 3 illustrates an embodiment where firmware 312 is stored within the physical memory 316 of virtualization server 301. Programs or executable instructions stored in the physical memory 316 can be executed by the one or more processors 308 of virtualization server 301.

Virtualization server 301 may also include a hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 can be any combination of executable instructions and hardware that monitors virtual machines executing on a computing machine. Hypervisor 302 may be Type 2 hypervisor, where the hypervisor executes within an operating system 314 executing on the virtualization server 301. Virtual machines may then execute at a level above the hypervisor 302. In some embodiments, the Type 2 hypervisor may execute within the context of a user’s operating system such that the Type 2 hypervisor interacts with the user’s operating system. In other embodiments, one or more virtualization servers 301 in a virtualization environment may instead include a Type 1 hypervisor (not shown). A Type 1 hypervisor may execute on the virtualization server 301 by directly accessing the hardware and resources within the hardware layer 310. That is, while a Type 2 hypervisor 302 accesses system resources through a host operating system 314, as shown, a Type 1 hypervisor may directly access all system resources without the host operating system 314. A Type 1 hypervisor may execute directly on one or more physical processors 308 of virtualization server 301, and may include program data stored in the physical memory 316.

Hypervisor 302, in some embodiments, can provide virtual resources to operating systems 330 or control programs 320 executing on virtual machines 332 in any manner that simulates the operating systems 330 or control programs 320 having direct access to system resources. System resources can include, but are not limited to, physical devices 306, physical disks 304, physical processors 308, physical memory 316, and any other component included in hardware layer 310 of the virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for a virtual machine 332 executing on virtualization server 301. Hypervisor 302 may include those manufactured by VMWare, Inc., of Palo Alto, California; HyperV, VirtualServer or virtual PC hypervisors provided by Microsoft, or others. In some embodiments, virtualization server 301 may execute a hypervisor 302 that creates a virtual machine platform on which guest operating systems may execute. In these embodiments, the virtualization server 301 may be referred to as a host server. An example of such a virtualization server is the Citrix Hypervisor provided by Citrix Systems, Inc., of Fort Lauderdale, FL.

Hypervisor 302 may create one or more virtual machines 332B-C (generally 332) in which guest operating systems 330 execute. In some embodiments, hypervisor 302 may load a virtual machine image to create a virtual machine 332. In other embodiments, the hypervisor 302 may execute a guest operating system 330 within virtual machine 332. In still other embodiments, virtual machine 332 may execute guest operating system 330.

In addition to creating virtual machines 332, hypervisor 302 may control the execution of at least one virtual machine 332. In other embodiments, hypervisor 302 may present at least one virtual machine 332 with an abstraction of at least one hardware resource provided by the virtualization server 301 (e.g., any hardware resource available within the hardware layer 310). In other embodiments, hypervisor 302 may control the manner in which virtual machines 332 access physical processors 308 available in virtualization server 301. Controlling access to physical processors 308 may include determining whether a virtual machine 332 should have access to a processor 308, and how physical processor capabilities are presented to the virtual machine 332.

As shown in FIG. 3, virtualization server 301 may host or execute one or more virtual machines 332. A virtual machine 332 is a set of executable instructions that, when executed by a processor 308, may imitate the operation of a physical computer such that the virtual machine 332 can execute programs and processes much like a physical computing device. While FIG. 3 illustrates an embodiment where a virtualization server 301 hosts three virtual machines 332, in other embodiments virtualization server 301 can host any number of virtual machines 332. Hypervisor 302, in some embodiments, may provide each virtual machine 332 with a unique virtual view of the physical hardware, memory, processor, and other system resources available to that virtual machine 332. In some embodiments, the unique virtual view can be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to the virtual machines 332.

Each virtual machine 332 may include a virtual disk 326A-C (generally 326) and a virtual processor 328A-C (generally 328.) The virtual disk 326, in some embodiments, is a virtualized view of one or more physical disks 304 of the virtualization server 301, or a portion of one or more physical disks 304 of the virtualization server 301. The virtualized view of the physical disks 304 can be generated, provided, and managed by the hypervisor 302. In some embodiments, hypervisor 302 provides each virtual machine 332 with a unique view of the physical disks 304. Thus, in these embodiments, the particular virtual disk 326 included in each virtual machine 332 can be unique when compared with the other virtual disks 326.

A virtual processor 328 can be a virtualized view of one or more physical processors 308 of the virtualization server 301. In some embodiments, the virtualized view of the physical processors 308 can be generated, provided, and managed by hypervisor 302. In some embodiments, virtual processor 328 has substantially all of the same characteristics of at least one physical processor 308. In other embodiments, virtual processor 308 provides a modified view of physical processors 308 such that at least some of the characteristics of the virtual processor 328 are different than the characteristics of the corresponding physical processor 308.

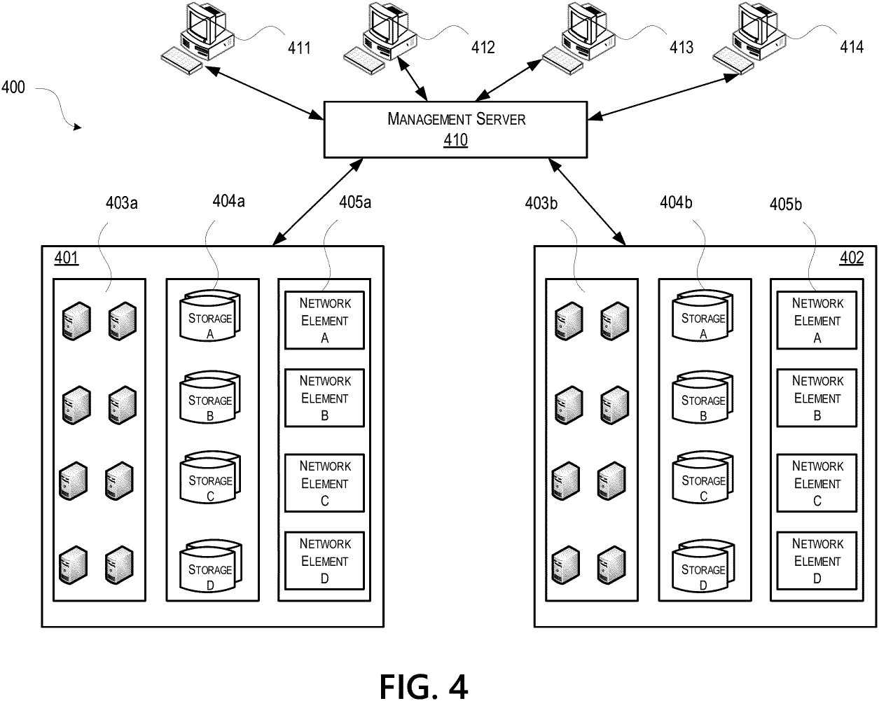

With further reference to FIG. 4, some aspects described herein may be implemented in a cloud-based environment. FIG. 4 illustrates an example of a cloud computing environment (or cloud system) 400. As seen in FIG. 4, client computers 411-414 may communicate with a cloud management server 410 to access the computing resources (e.g., host servers 403a-403b (generally referred herein as “host servers 403”), storage resources 404a-404b (generally referred herein as “storage resources 404”), and network elements 405a-405b (generally referred herein as “network resources 405”)) of the cloud system.

Management server 410 may be implemented on one or more physical servers. The management server 410 may run, for example, Citrix Cloud by Citrix Systems, Inc. of Ft. Lauderdale, FL, or OPENSTACK, among others. Management server 410 may manage various computing resources, including cloud hardware and software resources, for example, host computers 403, data storage devices 404, and networking devices 405. The cloud hardware and software resources may include private and/or public components. For example, a cloud may be configured as a private cloud to be used by one or more particular customers or client computers 411-414 and/or over a private network. In other embodiments, public clouds or hybrid public-private clouds may be used by other customers over an open or hybrid networks.

Management server 410 may be configured to provide user interfaces through which cloud operators and cloud customers may interact with the cloud system 400. For example, the management server 410 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and perform other cloud administration tasks. The management server 410 also may include a set of APIs and/or one or more customer console applications with user interfaces configured to receive cloud computing requests from end users via client computers 411-414, for example, requests to create, modify, or destroy virtual machines within the cloud. Client computers 411-414 may connect to management server 410 via the Internet or some other communication network, and may request access to one or more of the computing resources managed by management server 410. In response to client requests, the management server 410 may include a resource manager configured to select and provision physical resources in the hardware layer of the cloud system based on the client requests. For example, the management server 410 and additional components of the cloud system may be configured to provision, create, and manage virtual machines and their operating environments (e.g., hypervisors, storage resources, services offered by the network elements, etc.) for customers at client computers 411-414, over a network (e.g., the Internet), providing customers with computational resources, data storage services, networking capabilities, and computer platform and application support. Cloud systems also may be configured to provide various specific services, including security systems, development environments, user interfaces, and the like.

Certain clients 411-414 may be related, for example, to different client computers creating virtual machines on behalf of the same end user, or different users affiliated with the same company or organization. In other examples, certain clients 411-414 may be unrelated, such as users affiliated with different companies or organizations. For unrelated clients, information on the virtual machines or storage of any one user may be hidden from other users.

Referring now to the physical hardware layer of a cloud computing environment, availability zones 401-402 (or zones) may refer to a collocated set of physical computing resources. Zones may be geographically separated from other zones in the overall cloud of computing resources. For example, zone 401 may be a first cloud datacenter located in California, and zone 402 may be a second cloud datacenter located in Florida. Management server 410 may be located at one of the availability zones, or at a separate location. Each zone may include an internal network that interfaces with devices that are outside of the zone, such as the management server 410, through a gateway. End users of the cloud (e.g., clients 411-414) might or might not be aware of the distinctions between zones. For example, an end user may request the creation of a virtual machine having a specified amount of memory, processing power, and network capabilities. The management server 410 may respond to the user’s request and may allocate the resources to create the virtual machine without the user knowing whether the virtual machine was created using resources from zone 401 or zone 402. In other examples, the cloud system may allow end users to request that virtual machines (or other cloud resources) are allocated in a specific zone or on specific resources 403-405 within a zone.

In this example, each zone 401-402 may include an arrangement of various physical hardware components (or computing resources) 403-405, for example, physical hosting resources (or processing resources), physical network resources, physical storage resources, switches, and additional hardware resources that may be used to provide cloud computing services to customers. The physical hosting resources in a cloud zone 401-402 may include one or more computer servers 403, such as the virtualization servers 301 described above, which may be configured to create and host virtual machine instances. The physical network resources in a cloud zone 401 or 402 may include one or more network elements 405 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 401-402 may include storage disks (e.g., solid state drives (SSDs), magnetic hard disks, etc.) and other storage devices.

The example cloud computing environment shown in FIG. 4 also may include a virtualization layer (e.g., as shown in FIGS. 1-3) with additional hardware and/or software resources configured to create and manage virtual machines and provide other services to customers using the physical resources in the cloud. The virtualization layer may include hypervisors, as described above in FIG. 3, along with other components to provide network virtualizations, storage virtualizations, etc. The virtualization layer may be as a separate layer from the physical resource layer, or may share some or all of the same hardware and/or software resources with the physical resource layer. For example, the virtualization layer may include a hypervisor installed in each of the virtualization servers 403 with the physical computing resources. Known cloud systems may alternatively be used, e.g., WINDOWS AZURE (Microsoft Corporation of Redmond Washington), AMAZON EC2 (Amazon.com Inc. of Seattle, Washington), IBM BLUE CLOUD (IBM Corporation of Armonk, New York), or others.

### Example System for Supporting Multiple Local Browser Tabs and Windows

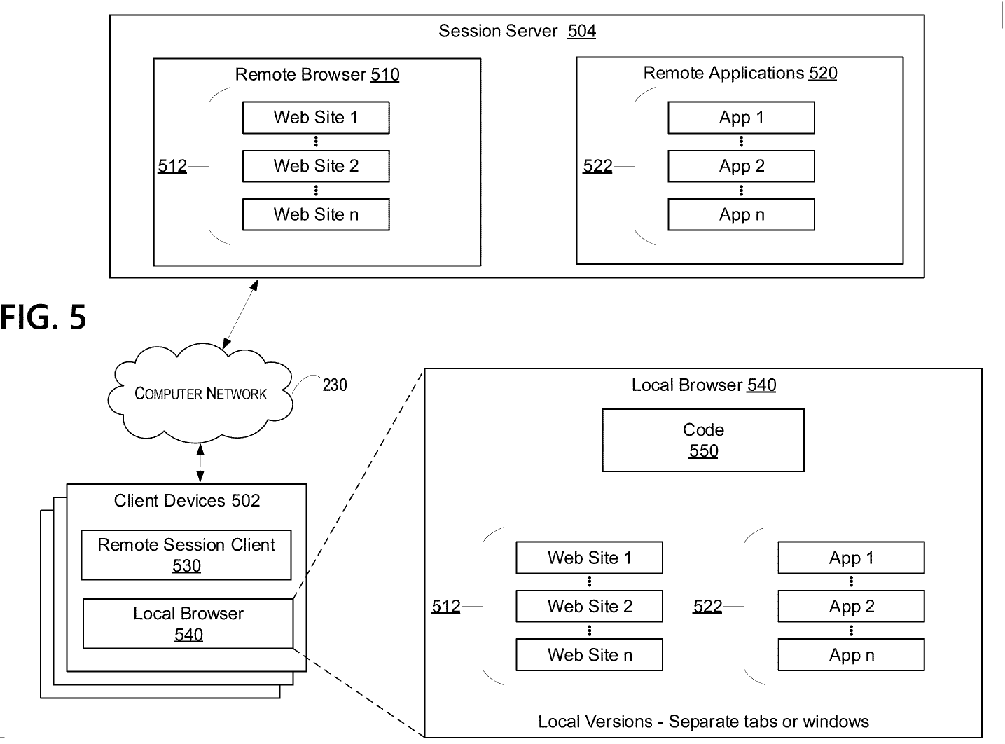

FIG. 5 depicts an illustrative platform architecture that may be used in accordance with one or more illustrative aspects described herein. As shown, client devices 502 may communicate to a session server through a computer network 230. The devices may be implemented or performed, for example, by one or more of the systems as discussed in connection with FIGS. 1-4. The devices may operate in a networked environment, for example, transferring data over networks such as computer network 230 (e.g., the Internet). It will be appreciated that the network connections shown are illustrative and other means of establishing a communications link between the devices may be used.

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like. In some implementations, native messaging may be accomplished by extensions or other code or scripts running in the local computing environment allowing for exchanging of messages with a native (local) application. In some implementations, remote messaging may be exchanging of messages with remote computing systems. For example, such messaging may be through a virtual channel opened to the remote computing system.

Client devices 502 may comprise a remote session client 530 and a local browser 540. Local browser 405 may comprise code 550. For example, code 550 may be a browser script. Local browser 540 may further comprise local versions of some number of remote web sites (e.g., web sites 1-n 512) which are locally displayed versions of the remote versions. In some examples, there may be no remote websites 512. Local browser 540 may further comprise local versions of some number of remote apps (e.g., remote apps 1-n 522) which are locally displayed versions of the remote apps. In some examples, there may be no remote apps 522.

In some implementations, local browser 540 may be configured to monitor requests to launch new remote applications or web pages (e.g., using code 550). For example, code 550 may be a browser extension and local browser 540 may use the browser extension to monitor requests to launch new remote applications or web pages. In some implementations, local browser 540 may be configured to intercept the request, as explained in more detail below.

In some implementations, local browser 540 may be configured to send a tab identifier (tab ID) of a tab of a local web browser along with the request. The request may be sent to a native process that may be operating a remote session. In some implementations, the tab ID and the request are sent to a remote session client (e.g., remote session client 530). In some implementations, the tab ID comprises an identification of a tab that may be newly opened on a local web browser. The newly opened tab may also be in a newly opened window of the local web browser. In some implementations, whether the tab is in a newly opened window or just in a new tab of the window already opened may be determined by a configuration setting. In some other implementations, it may be determined from data included in the request, read from a configuration file, determined based on user input, and the like. In some examples, the request comprises information on the web page to be opened or the application to be started. In some examples, there request further comprises startup configuration information for the web page or application. In some implementations, the remote session client associates a requested web page or application that may be part of the request with the tab ID. This association may be used when subsequently relaying data from a session server to the script. In some implementations, the local browser 540 may be configured to communicate to the remote session client through native messaging. For example, the communications may be enabled by extending a browser native protocol.

In some implementations, local browser 540 may be configured to receive remote images (e.g., bitmap images) along with the tab ID. In some implementations, the images along with the tab ID are received from a native process operating the remote session. The native process may just be forwarding the images being received from a session server. In some implementations, the remote session client first associates individual images to the appropriate and respective tab ID before sending.

In some implementations, local browser 540 may be configured to display individual images on a web browser tab. The web browser tab may be associated with the tab ID. In some implementations, the images may be displayed in a tab that is associated with the received tab ID. In some examples, the tab may be a top-level tab of local browser 540. In some examples, the tab may be opened in its own window (not in a tab running a shared session). In some implementations, local browser 540 may be configured to paint or otherwise render images on a canvas associated with relevant tab ID of an image.

In some implementations, remote session client 530 may be configured to receive a request and a tab ID. In some implementations, the tab ID and the request are sent by a local browser 540 (e.g., via code 550). In some implementations, the tab ID comprises an identification of a tab that may be newly opened on the local browser. The newly opened tab may also be in a newly opened window of the local web browser. In some implementations, whether the tab is in a newly opened window or just in a new tab of the window already opened may be determined by a configuration setting. In some other implementations, it may be determined from data included in the request, read from a configuration file, determined based on user input, and the like. In some examples, the request comprises information on the web page to be opened or the application to be started. In some examples, the request further comprises information (e.g., startup configuration information) for the web page or application. In some implementations, remote session client 530 may be configured to associate a requested web page or application that is part of the request with the tab ID. The remote session client 530 may further be configured to use this association when subsequently relaying data from a session server to the script. In some implementations, the remote session client 530 may be configured to communicate to the code through native messaging. For example, the communications may be enabled by extending a browser native protocol.

In some implementations, remote session client 530 may be configured to determine if the request is associated with a remote session. In some implementations, the determination is made through determining that an input initiating the request is directed to a remote session that is already running. The remote session may be running in an already open local browser tab. In some implementations, the determination is made by analyzing the contents of the request or analyzing accompanying metadata. The remote session client 530 may be configured to launch a new remote session or continue with an already launched remote session if the request is associated with a remote session. In some implementations, remote session client 530 may be configured to launch a remote session before executing the request. In some implementations, the remote session may already be started on a session server and the new remote application or web page is to be launched in the already started remote session. In one example, the remote session may be an Independent Computing Architecture (ICA) session. In another example, it may be a Remote Desktop Protocol (RDP) session. The remote session may use other known remote session protocols that support device applications to run on the server hosting the remote session (e.g., session server 504).

In some implementations, remote session client 530 may be configured to receive images (e.g., remote bitmap images). In some implementations, the images are sent from a session server (e.g., session server 504). The images may be generated due to the session server running an application or a remote browser running a web page. For example, there is a request to launch a web page in a remote session, the request is forwarded to the session server which launches the web page on a remote browser and images from the web page are sent by the session server back to a client device. In another example, there is a request to launch a remote application, the request is forwarded to the session server which launches the application and images from the application are sent by the session server back to a client device. In some implementations, the images are sent through a virtual channel. In some implementations, the images may be sent through seamless session technology. In some implementations, other information may also be sent through seamless session technology such as remote window size, position, and the like.

In some implementations, remote session client 530 may be configured to send the images on along with a tab ID. In some implementations, remote session client 530 may be configured to send the images and their associated tab ID to a local browser (e.g., via code 550). In some implementations, remote session client 530 may be configured to forward the images being received from a session server. In some implementations, the remote session client 530 may be configured to first associate individual images to the appropriate and respective tab ID before sending.

Session server 504 may comprise a remote browser 510 and remote applications 512. Remote browser 510 may comprise some number of remote web sites (e.g., web sites 1-n 512). In some examples, there may be no remote websites 512. Remote applications 520 may comprise some number of remote apps (e.g., remote apps 1-n 522). In some examples, there may be no remote apps 522.

In some implementations, session server 504 may be configured to launch a remote session upon request. For example, a remote session client 530 may send a request to launch a new session. In one example, the remote session may be an Independent Computing Architecture (ICA) session. In another example, it may be a Remote Desktop Protocol (RDP) session. The remote session may use other known remote session protocols that support device applications to run on the server (e.g., session server 504).

In some implementations, session server 504 may be configured to send images (e.g., remote bitmap images). In some implementations, the images are sent to a remote session client (e.g., remote session client 530). The images may be generated due to the session server running an application or a remote browser running a web page. For example, there is a request to launch a web page in a remote session, the request is forwarded to the session server which launches the web page on a remote browser and images from the web page are sent by the session server back to a client device. In another example, there is a request to launch a remote application, the request is forwarded to the session server which launches the application and images from the application are sent by the session server back to a client device. In some implementations, session server 504 may be configured to send the images through a virtual channel. In some implementations, the images may be sent through seamless session technology. In some implementations, other information may also be sent through seamless session technology such as remote window size, position, and the like.

In some implementations, session server 504 may be configured to receive peripheral device inputs originating from a client device (e.g., client device 502) that are associated with a web page or application running on session server 504. The inputs may just be sent on from the remote session client without modification. In some implementations, the peripheral device inputs are sent through a virtual channel.

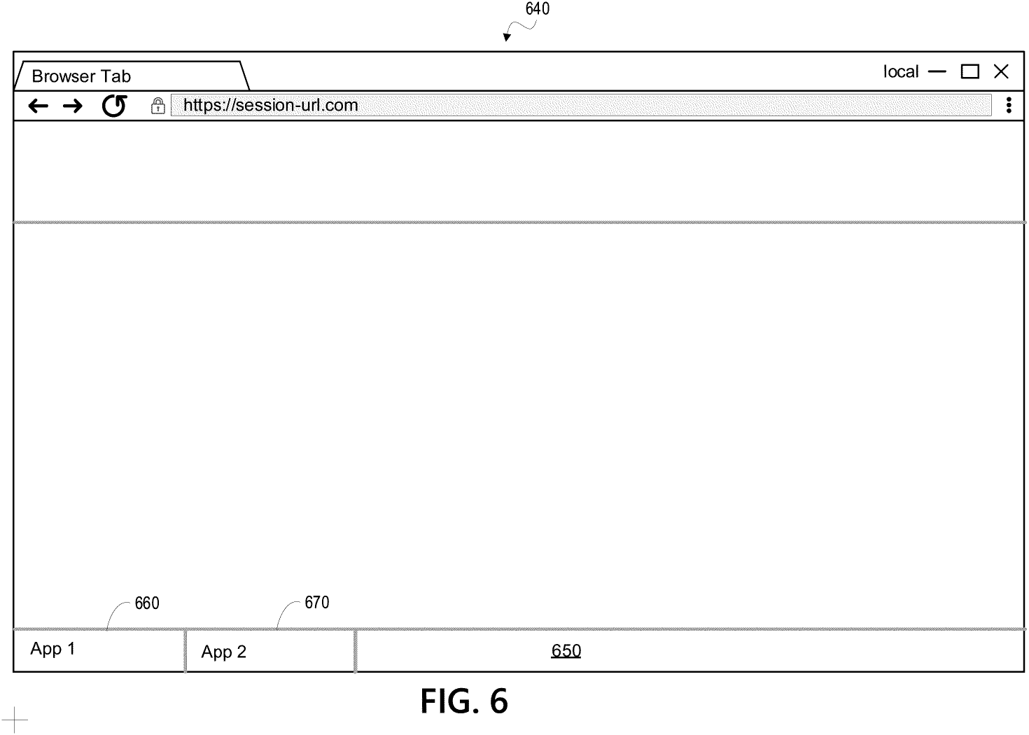

FIG. 6 depicts an illustration of a local or native web browser 640 to access a remote session. FIG. 6 illustrates a solution for switching applications that are bounded in a single tab that may be improved upon using the techniques and methods herein. Browser 640 is depicted accessing a remote session in a local browser tab and is using the remote session to launch web pages and applications on a server remotely rather than locally. Interactions with the web pages and applications may be limited to being within the local browser tab. A clientless receiver like an application switcher or app switcher 650 may be run inside the browser to switch between the applications and/or the web pages, such as App 1 660 and App 2 670. Applications and/or web pages may be selected for switching via a taskbar or grid-view list (not shown). However, use of an app switcher (e.g., app switcher 650) still limits the applications to the confines of a single local browser tab as the app switcher is running within the remote session being accessed from the single local browser tab. Since the app switcher is running within the remote session within the single local browser tab, it may not have access to open other local browser tabs or windows.

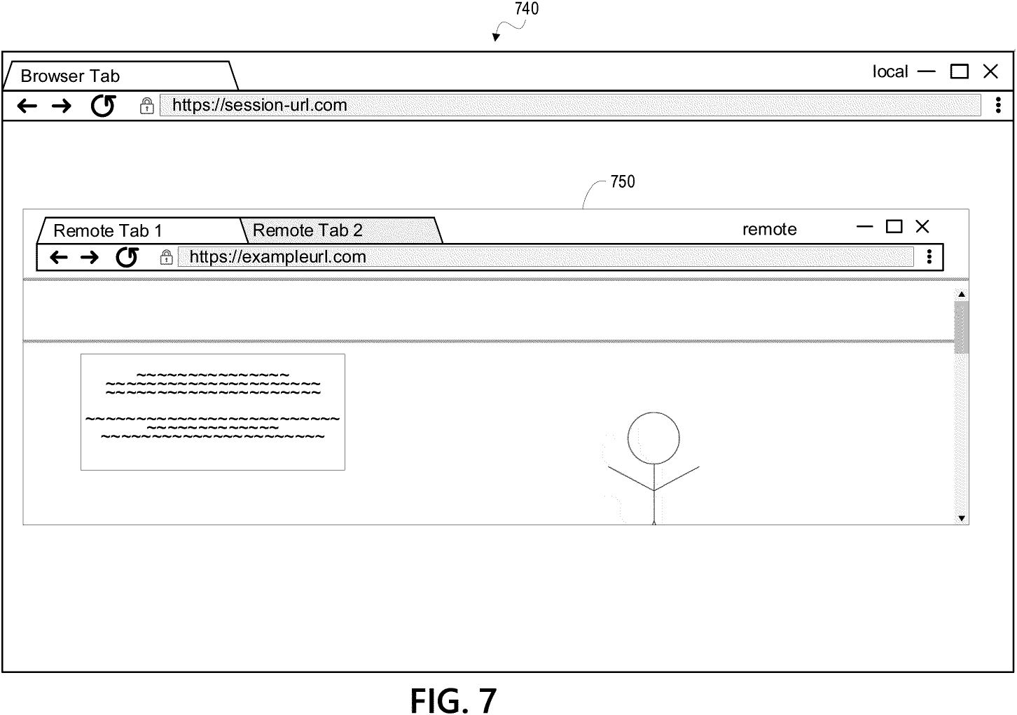

FIG. 7 depicts an illustration of a local or native web browser 740 with remote browser tabs bounded by a single tab. Browser 740 is depicted accessing a remote session in a local browser tab where a remote browser 750 is depicted and tabs in remote browser 750 may be running different applications or web pages (e.g., Tab 1 and Tab 2). Browser 740 is using the remote session to launch web pages and applications in these tabs on a server rather than locally. Interactions with the web pages and applications may be limited to being within the local browser tab. For example, Tab 1 and/or Tab 2 cannot be drag and dropped outside the local browser tab. In another example, Tab 1 and/or Tab 2 cannot be moved to a top-level tab of the local web browser. In another example, Tab 1 and/or Tab 2 cannot be drag and dropped outside the Browser 740 to be opened in a new window.

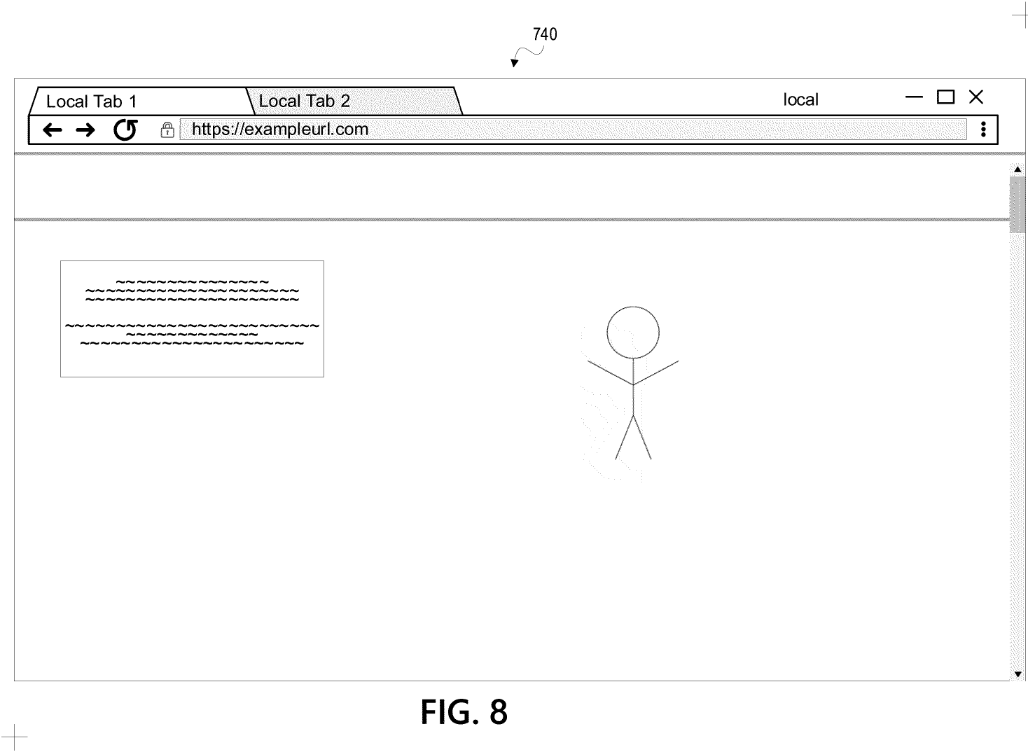

FIG. 8 depicts an illustration of the web browser remote session of FIG. 7 with the remote browser tabs no longer bounded by a single tab using techniques and methods described herein. FIG. 8 therefore presents an experience that may be more in line with expected interactions with local web browser tabs and windows. For example, switching between the remote web sites and/or different applications may be accomplished by clicking on local browser tabs present at the top of the local web browser. In another example, dragging and dropping tabs that are displaying the remote web sites and/or remote applications is similar to drag and drop functionality of local web browser tabs. In other words, a tab drag and dropped to a different open local browser window is moved to a tab position of the different open local browser window. A tab drag and dropped outside the local web browser window opens in its own local web browser window and so forth.

### Data Movement Schematic

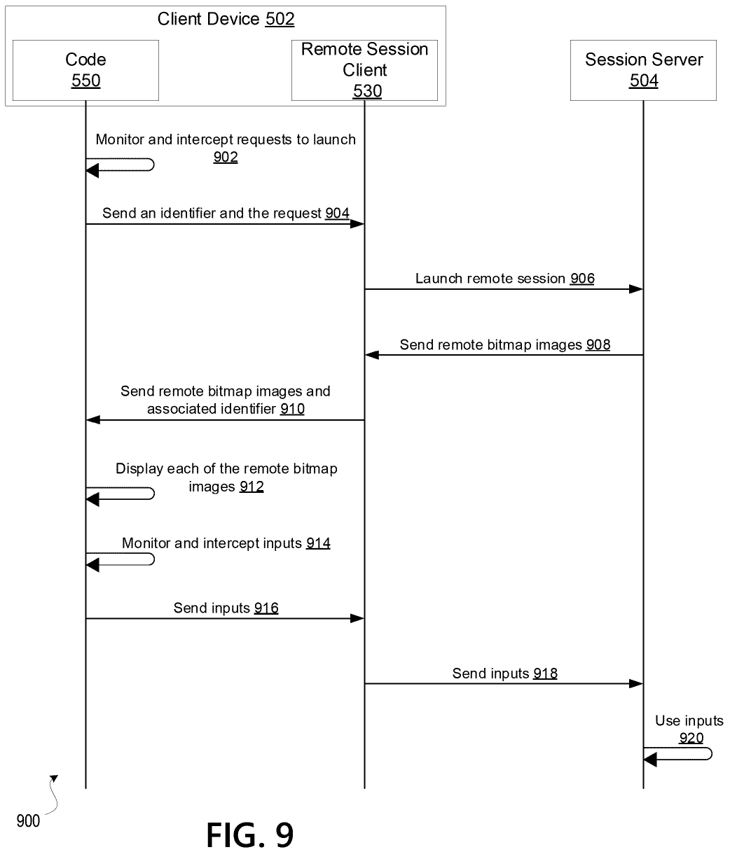

FIG. 9 depicts a schematic representation of data movement 900 for supporting multiple local browser tabs and windows during a remote browser session. The data movement may allow for the multiple local browser tabs and windows to appear and act as normal local browser tabs and windows even though they are part of the same shared remote session. In other words, the web pages and/or applications in the multiple local browser tabs and windows are not bounded inside a single browser tab. Data movement is shown between a client device (e.g., client device 502) comprising a remote session client (e.g., remote session client 530) and a code (e.g., code 550) and a session server (e.g., session server 504). The steps shown for data movement may be performed by multiple computing devices. For example, the steps shown for data movement may be performed by one or more of the systems as discussed in connection with FIGS. 1-5. One or more steps may be omitted, added, rearranged, and/or otherwise modified as desired by a person of ordinary skill in the art. In some implementations, the functionality of the shown code 550 may be a browser extension. In some implementations, the functionality of the shown code 550 may be implemented by one or more other processes running on a computing device. For example, the functionality of the shown code 550 may instead be implemented as an HTML5 client.

In step 902, a code (e.g., code 550) monitors and intercepts requests to launch remote applications or web pages in a tab of a local web browser. In some examples, a remote session to a server (e.g., session server 504) may be already running inside the tab of the local web browser and the request to launch a new remote application or web page may be directed to the remote session running in the tab of the local web browser. In some examples, a remote session to a remote server is first started consequent to the request being intercepted.

In step 904, a code (e.g., code 550) sends a tab ID and the request. In some implementations, the tab ID and the request are received by a remote session client (e.g., remote session client 530). In some implementations, the tab ID comprises an identification of a tab that may be newly opened on a local web browser. The newly opened tab may also be in a newly opened window of the local web browser. In some implementations, whether the tab is in a newly opened window or just in a new tab of the window already opened may be determined by a configuration setting. In some other implementations, it may be determined from data included in the request, read from a configuration file, determined based on user input, and the like. In some examples, the request comprises information on the web page to be opened or the application to be started. In some examples, the request further comprises information (e.g., startup configuration information) for the web page or application. In some implementations, the remote session client associates a requested web page or application that may be part of the request with the tab ID. This association may be used when subsequently relaying data from a session server to the code. In some implementations, the communications between a code and the remote session client may be through native messaging. For example, the communications may be enabled by extending a browser native protocol.

In step 906, a remote session client (e.g., remote session client 530) may launch a remote session. In some implementations, the remote session may already be started on a session server and the new remote application or web page is to be launched in the already started remote session. In one example, the remote session may be an Independent Computing Architecture (ICA) session. In another example, it may be a Remote Desktop Protocol (RDP) session. The remote session may use other known remote session protocols that support device applications to run on the server hosting the remote session (e.g., session server 504).

In step 908, a session server (e.g., session server 504) may send images (e.g., remote bitmap images). In some implementations, the images are sent to a remote session client (e.g., remote session client 530). The images may correspond to images generated due to the session server running an application or a remote browser running a web page. For example, there may be a request to launch a web page in a remote session, the request may be forwarded to the session server which launches the web page on a remote browser and images from the web page are sent by the session server back to a client device. In another example, there may be a request to launch a remote application, the request may be forwarded to the session server which launches the application and images from the application are sent by the session server back to a client device. In some implementations, the images are sent through a virtual channel. In some implementations, the images may be sent through seamless session technology. In some implementations, other information may also be sent through seamless session technology such as remote window size, position, and the like.

In step 910, a remote session client (e.g., remote session client 530) may send the images (e.g., remote bitmap images) and their associated tab ID. In some implementations, the images and their associated tab ID are sent to the code (e.g., code 550). The remote session client may just be forwarding the images received from a session server. In some implementations, the remote session client first associates individual images to the appropriate and respective tab ID before sending.

In step 912, the code (e.g., code 550) may display individual images received. In some implementations, individual images may be displayed in a tab that may be associated with the received tab ID. In some examples, the tab may be a top-level tab of a local web browser (not in a tab running a shared session). In some examples, the tab may be opened in its own window (not in a tab running a shared session). In some implementations, individual images may be painted or otherwise provided on a canvas associated with relevant tab ID of a respective image sent.

In step 914, inputs associated with a respective tab are monitored and intercepted. In some implementations, the inputs may be monitored and intercepted by the code. The inputs may be to a local browser tab that may be displaying a remote web page or a remote application. In some implementations, inputs may be mouse clicks, mouse position, touchscreen, keyboard, and other user inputs. In some implementations, inputs may also page navigation events in the local web browser (e.g., pressing back button, pressing forward button, pressing refresh button, providing a second URL, and the like). In some implementations, inputs are monitored and intercepted at the operating system level. For example, in a given open window of an operating system, events are captures via a local native process (e.g., an Independent Computing Architecture (ICA) engine).

In step 916, inputs associated with a respective tab are sent. In some implementations, they are sent to a remote session client from the code. The inputs may have accompanying metadata. Metadata may include such as a relative position on a screen associated with the input and the like. They may be sent along with the respective tab ID. In some implementations, the remote session client associates the inputs with the respective tab IDs. In some implementations, inputs are monitored and intercepted at the operating system level. For example, in a given open window of an operating system, the input events that are captured via a local native process (e.g., an Independent Computing Architecture (ICA) engine) are sent in a virtual channel.

In step 918, inputs that are associated with a respective tab are sent on. In some implementations, the inputs are sent to a session server. The inputs may just be sent on from the remote session client without modification. They may be sent along with the respective tab ID. In some implementations, the inputs are sent through a virtual channel.

In step 920, the inputs are used. In some implementations, they may be used by the session server. For example, the inputs are used to interact with, enter data into, or otherwise control aspects of the respective web page or application.

### Method Flowcharts

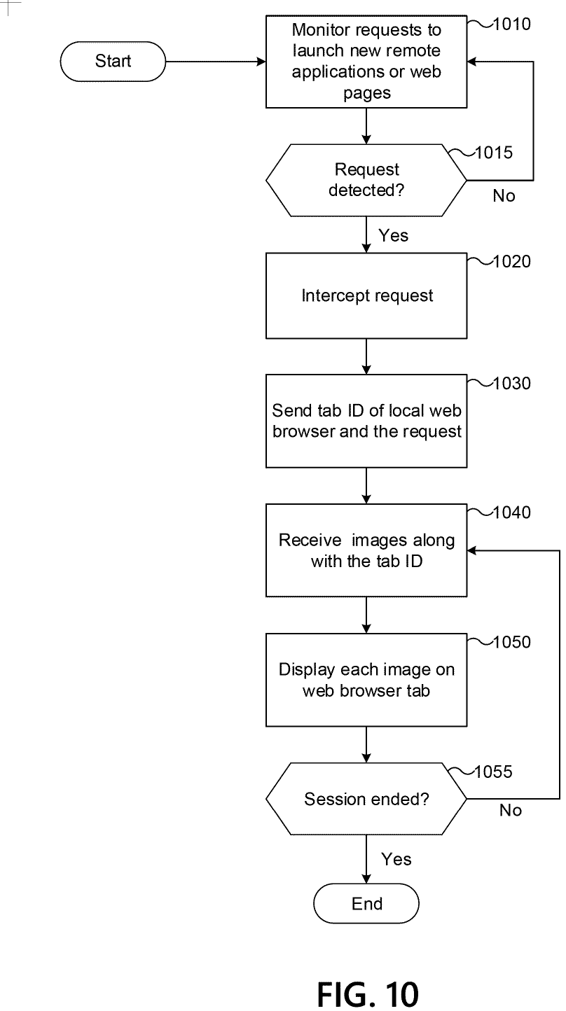

FIG. 10 depicts a flowchart showing an example method for separating multiple local browser tabs and windows for remote content in some implementations. The spanning of the remote content across multiple local browser tabs allows for a user experience closer to a user accessing local content. The method may be implemented or performed, for example, by one or more of the systems as discussed in connection with FIGS. 1-5. The method may be implemented or performed, for example, by one or more computing devices. The method may be implemented, for example, by a client device 502. The method may be implemented, for example, by code 550 or functionally equivalent software process. The steps of the method may be described as being performed by particular components and/or computing devices for the sake of simplicity, but the steps may be performed by any component and/or computing device, or by any combination of one or more components and/or one or more computing devices. The steps of the method may be performed by a single computing device or by multiple computing devices. One or more steps of the method may be omitted, added, rearranged, and/or otherwise modified as desired by a person of ordinary skill in the art.

The steps depicted in FIG. 10 may include monitoring requests to launch new remote applications or web pages (1010). The computing device may be a device as described above. The computing device may determine if a request has been detected (1015). If a request has not been detected, the process may return to step 1010 to continue monitoring. If a request has been detected, the computing device may proceed to intercept the request (1020). The computing device may send a tab ID of a local web browser and the request (1030). The computing device may receive images (e.g., remote bitmap images) along with the associated tab ID (1040). The computing device may display images (e.g., remote bitmap images) on a web browser tab, using the associated tab ID (1050). The computing device may determine if the session has ended. If the session has not ended, the computing device may return to step 1040 to continue receiving images. If the session has ended, the process may end.

Still referring to FIG. 10 and in more detail, a computing device may monitor requests to launch new remote applications or web pages (1010). The computing device may be as described above. In some implementations, the computing device may monitor requests to launch new remote applications or web pages in a tab of a local web browser. Monitoring requests may be done by monitoring inputs directed to a remote session running in a tab of a local web browser. In some implementations, inputs may be mouse clicks, mouse position, touchscreen, keyboard, and other user inputs. In some implementations, inputs may also page navigation events in the local web. In some implementations, inputs are monitored at the operating system level. For example, in a given open window of an operating system, events are captured via a local native process (e.g., an Independent Computing Architecture (ICA) engine). In some examples, a remote session to a server (e.g., session server 504) may be already running inside the tab of the local web browser and the request to launch a new remote application or web page may be directed to the remote session running in the tab of the local web browser. In some examples, a remote session to a remote server is first started consequent to the request being intercepted.

The computing device may determine if a request has been detected (1015). In some implementations, a determination that a request has been made is determined if a monitored input is directed to a remote session running in a tab of a local web browser. If a request is not detected (1015:NO), then the process may return to step 1010 to continue monitoring. If a request is detected (1015:YES), the process may continue to step 1020.

The computing device may intercept the request (1020). In some implementations, the computing device monitors and intercepts requests to launch new remote applications or web pages in a tab of a local web browser. Intercepting requests may be done by intercepting the monitored inputs directed to a remote session running in a tab of a local web browser. In some implementations, inputs are intercepted at the operating system level. For example, in a given open window of an operating system, events are captured via a local native process (e.g., an Independent Computing Architecture (ICA) engine). Intercepting requests may prevent them from reaching the remote session running in the tab of the local browser. For example, the request is prevented from reaching the remote session running in the tab of the local browser and is instead directed to a native process that may be accessing a remote session (e.g., a remote session client).

The computing device may send an identifier (e.g., a tab ID) of a local web browser and the request (1030). In some implementations, the request may be sent to a native process that may be accessing a remote session. In some implementations, the identifier and the request are received by a remote session client (e.g., remote session client 530). In some implementations, the identifier comprises an identification of a tab that may be newly opened on a local web browser. The newly opened tab may also be in a newly opened window of the local web browser. In some implementations, whether the tab is in a newly opened window or just in a new tab of the window already opened may be determined by a configuration setting. In some other implementations, the identifier may be determined from data included in the request, read from a configuration file, determined based on user input, and the like. In some examples, the request comprises information on the web page to be opened or the application to be started. In some examples, the request further comprises startup configuration information for the web page or application. In some implementations, the remote session client associates a requested web page or application that may be part of the request with the identifier. This association may be used when subsequently relaying data from a session server to the code. In some implementations, the communications between a code and the remote session client may be through native messaging. For example, the communications may be enabled by extending a browser native protocol.

The computing device may receive images (e.g., remote bitmap images) along with the identifier (e.g., a tab ID). In some implementations, the images along with the identifier are received from a native process operating the remote session. The native process may just be forwarding the images being received from a session server. In some implementations, the remote session client first associates individual images to the appropriate and respective identifier before sending.

The computing device may display images (e.g., remote bitmap images) on a web browser tab (1050). In some implementations, the web browser tab may be associated with the identifier (e.g., a tab ID). In some implementations, images may be displayed in a tab that may be associated with the received identifier. In some examples, the tab may be a top-level tab of a local web browser (not in a tab running a shared session). In some examples, the tab may be opened in its own window (not in a tab running a shared session). In some implementations, images may be painted or otherwise provided on a canvas associated with relevant identifier with which the respective image was sent.

The computing device may determine if the session has ended (1055). In some implementations, a session is ended upon detecting an input to end the remote session. For example, an input may be received to close a local web browser tab that is accessing the remote session and the remote session is ended automatically with the closing of the local web browser tab. In another example, a message may be received over a channel to the remote session that the remote session is being ended by a host of the remote session. Other events may close a remote session such as an error, a loss of network connectivity, and the like. If the session has not ended, the process may return to step 1040 to receive more images. If the session has ended, the process may end.

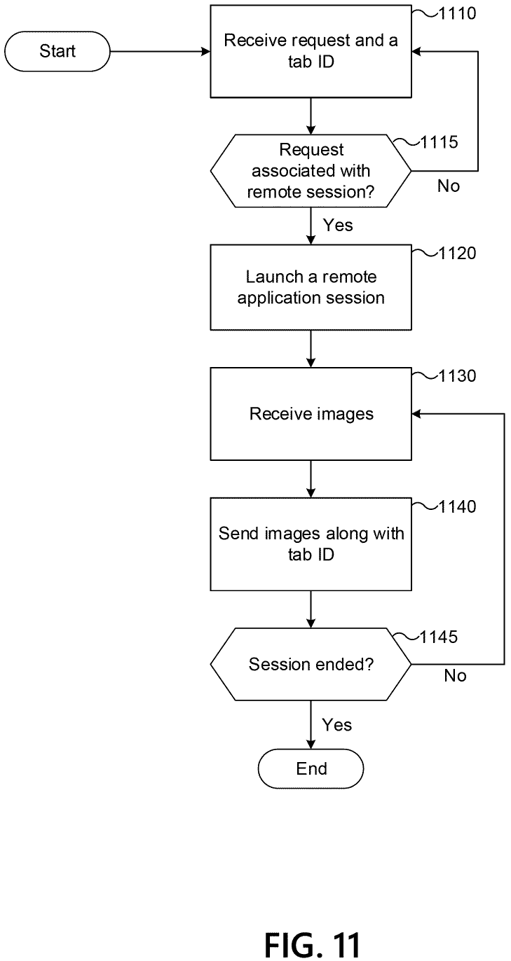

FIG. 11 depicts a flowchart showing an example method for a remote session that supports multiple local browser tabs and windows for remote content in some implementations. This support may allow for a user experience that is similar to accessing local content with local browser tabs and windows, which is often preferred by users. The method may be implemented or performed, for example, by one or more of the systems as discussed in connection with FIGS. 1-5. The method may be implemented or performed, for example, by one or more computing devices. The method may be implemented, for example, by a client device 502. The method may be implemented, for example, by a remote session client 530. The steps of the method may be described as being performed by particular components and/or computing devices for the sake of simplicity, but the steps may be performed by any component and/or computing device, or by any combination of one or more components and/or one or more computing devices. The steps of the method may be performed by a single computing device or by multiple computing devices. One or more steps of the method may be omitted, added, rearranged, and/or otherwise modified as desired by a person of ordinary skill in the art.

The steps depicted in FIG. 11 may include a computing device receiving a request and an identifier, such as a tab identifier (1110). The computing device may be a device as described above. The computing device may determine if the request is associated with a remote session (1115). If the request is not associated with a remote session, the process may return to step 1110. If the request is associated with a remote session, the computing device may launch or continue with an already launched remote session (1120). The computing device may receive images, such as remote bitmap images (1130). The computing device may send the images (e.g., remote bitmap images) on along with an identifier (e.g., a tab ID) (1140). The computing device may determine if the session is ended (1145). If the session is not ended, the process may return to step 1130 to continue receiving images. If the session is ended, the process may end.

Still referring to FIG. 11 and in more detail, a computing device may receive a request and an identifier (e.g., a tab ID) (1110). In some implementations, the identifier and the request are sent by a code (e.g., code 550). In some implementations, the identifier comprises an identification of a tab that may be newly opened on a local web browser. The newly opened tab may also be in a newly opened window of the local web browser. In some implementations, whether the tab may be in a newly opened window or just in a new tab of the window already opened may be determined by a configuration setting. In some other implementations, it may be determined from data included in the request, read from a configuration file, determined based on user input, and the like. In some examples, the request comprises information on the web page to be opened or the application to be started. In some examples, there request further comprises information (e.g., startup configuration information) for the web page or application. In some implementations, the computing device may associate a requested web page or application that may be part of the request with the identifier (e.g., a tab ID). This association may be used when subsequently relaying data from a session server to the code. In some implementations, the communication between the computing device and the code may be through native messaging. For example, the communication may be enabled by extending a browser native protocol.

The computing device may determine if the request is associated with a remote session (1115). In some implementations, the determination is made through determining that an input initiating the request is directed to a remote session that is already running. The remote session may be running in an already open local browser tab. In some implementations, the determination is made by analyzing the contents of the request or analyzing accompanying metadata. If the request is not associated with a remote session (1115:NO), the process may return to step 1110. If the request is associated with a remote session (1115:YES), the computing device may launch or continue with an already launched remote session (1120). In some implementations, the computing device may launch a remote session. In some implementations, the remote session may already be started on a session server and the new remote application or web page is to be launched in the already started remote session. In one example, the remote session may be an Independent Computing Architecture (ICA) session. In another example, it may be a Remote Desktop Protocol (RDP) session. The remote session may use other known remote session protocols that support device applications to run on the server hosting the remote session (e.g., session server 504).

The computing device may receive images (e.g., remote bitmap images) (1130). In some implementations, the images are sent from a session server (e.g., session server 504). The images may be generated due to the session server running an application or a remote browser running a web page. For example, there may be a request to launch a web page in a remote session, the request may be forwarded to the session server which launches the web page on a remote browser and images from the web page are sent by the session server back to a client device. In another example, the request may be forwarded to the session server which launches the application and images from the application are sent by the session server back to a client device. In some implementations, the images are sent through a virtual channel. In some implementations, the images may be sent through seamless session technology. In some implementations, other information may also be sent through seamless session technology such as remote window size, position, and the like.

The computing device may send the images (e.g., remote bitmap images) on along with an identifier, such as a tab ID (1140). In some implementations, the images and their associated identifier are sent to the code (e.g., code 550). The computing device may just be forwarding the images being received from a session server. In some implementations, the remote session client first associates the images to the appropriate and respective identifier before sending.

The computing device may determine of the session is ended (1145). If the session is not ended (1145:NO), the process may return to step 1130 to continue receiving images. If the session is ended, the process may end.

The following paragraphs (M1) through (M10) describe examples of methods that may be implemented in accordance with the present disclosure.

(M1) A method comprising accessing, by a client device, a remote computing session with use of a web browser executable on the client device, the remote computing session configured to provide the client device with access to applications hosted by a remote computing device; intercepting, by the client device, a request to launch an application hosted by the remote computing device; determining, by the client device, an identifier for a tab of the web browser on which to render at least one image of the application indicated by the intercepted request; receiving, by the client device, the image of the application from the remote computing device; and rendering, by the client device, the at least one image of the application within the tab of the web browser based on the determined identifier.

(M2) A method may be performed as described in paragraph (M1) wherein there is a plurality of applications or web pages hosted by the remote computing device in a plurality of web browser tabs, each associated with a respective identifier for the tab and respective images are displayed on each of the respective web browser tabs associated with respective identifiers.

(M3) A method may be performed as described in paragraph (M2) wherein the respective images are received from a plurality of tabs hosted by the remote computing device and one of the plurality of tabs from the remote computing device is active and another of the plurality of tabs from the remote computing device is inactive.

(M4) A method may be performed as described in any of paragraphs (M1) through (M3) further comprising receiving, by a native process running on the client device, the identifier for the tab of the web browser; accessing, by the native process using the request, the remote computing session consequent to receiving the identifier for the tab of the web browser; receiving, by the native process, the image of the application from the remote computing device; and sending, by the native process, the image of the application to the web browser along with the identifier for the tab of the web browser.

(M5) A method may be performed as described in paragraph (M4) wherein the image of the application to the web browser is received by the native process via a virtual channel.

(M6) A method may be performed as described in any of paragraphs (M1) through (M5) wherein the client device intercepts inputs from a peripheral input device and redirects them to the remote session.

(M7) A method may be performed as described in any of paragraphs (M1) through (M6) wherein the client device uses a browser extension to intercept the request to launch the application hosted by the remote computing device.

(M8) A method may be performed as described in any of paragraphs (M1) through (M6) wherein the client device uses an HTML5 client to intercept the request to launch the application hosted by the remote computing device.

(M9) A method may be performed as described in any of paragraphs (M1) through (M8) wherein a browser native protocol of the web browser has been extended to enable the sending of the identifier and the request to the remote session.

(M10) A method may be performed as described in any of paragraphs (M1) through (M9) wherein the image of the application to the web browser is displayed by painting the image on a canvas of the tab associated with the identifier.

The following paragraphs (A1) through (A8) describe examples of computing devices that may be implemented in accordance with the present disclosure.

(A1) A computing device comprising: one or more processors; and memory storing instructions that, when executed by the one or more processors, cause the computing device to: access a remote computing session with use of a web browser executable on the computing device, the remote computing session configured to provide the computing device with access to applications hosted by a remote computing device; intercept a request to launch an application hosted by the remote computing device; determine an identifier for a tab of the web browser on which to render at least one image of the application indicated by the intercepted request; receive the image of the application from the remote computing device; and render the at least one image of the application within the tab of the web browser based on the determined identifier.

(A2) A computing device may be implemented as described in paragraph (A1), wherein there is a plurality of applications or web pages hosted by the remote computing device in a plurality of web browser tabs, each associated with a respective identifier for the tab and respective images are displayed on each of the respective web browser tabs associated with respective identifiers.

(A3) A computing device may be implemented as described in paragraph (A2), wherein the respective images are received from a plurality of tabs hosted by the remote computing device and one of the plurality of tabs from the remote computing device is active and another of the plurality of tabs from the remote computing device is inactive.

(A4) A computing device may be implemented as described in any of paragraphs (A1) through (A3) the memory further storing instructions that when executed by the one or more processors, cause the computing device to: receive, by a native process running on the computing device, the identifier for the tab of the web browser; access, by the native process using the request, the remote computing session consequent to receiving the identifier for the tab of the web browser; receive, by the native process, the image of the application from the remote computing device; send, by the native process, the image of the application to the web browser along with the identifier for the tab of the web browser.

(A5) A computing device may be implemented as described in paragraph (A4) wherein the image of the application to the web browser is received by the native process via a virtual channel.

(A6) A computing device may be implemented as described in any of paragraphs (A1) through (A5) wherein the computing device intercepts inputs from a peripheral input device and redirects them to the remote session.

(A7) A computing device may be implemented as described in any of paragraphs (A1) through (A6) wherein the computing device uses a browser extension to intercept the request to launch the application hosted by the remote computing device.

(A8) A computing device may be implemented as described in any of paragraphs (A1) through (A6) wherein the computing device uses an HTML5 client to intercept the request to launch the application hosted by the remote computing device.

(A9) A computing device may be implemented as described in any of paragraphs (A1) through (A8) wherein a browser native protocol of the web browser has been extended to enable the sending of the identifier and the request to the remote session.

The following paragraph (CRM1) describes an example of computer-readable media that may be implemented in accordance with the present disclosure.

(CRM1) A non-transitory computer-readable medium storing instructions that, when executed, cause a computing device to: access a remote computing session with use of a web browser executable on the computing device, the remote computing session configured to provide the computing device with access to applications hosted by a remote computing device; intercept a request to launch an application hosted by the remote computing device; determine an identifier for a tab of the web browser on which to render at least one image of the application indicated by the intercepted request; receive, by a native process running on the computing device, the identifier for the tab of the web browser; access, by the native process using the request, the remote computing session consequent to receiving the identifier for the tab of the web browser; receive, by the native process, the image of the application from the remote computing device; and render the at least one image of the application within the tab of the web browser based on the determined identifier.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method comprising;
accessing, by a client device, a remote computing session with use of a web browser executable on the client device, the remote computing session configured to provide the client device with access to applications hosted by a remote computing device;
intercepting, by the client device, a request to launch an application hosted by the remote computing device;
determining, by the client device, an identifier for a tab of the web browser on which to render at least one image of the application indicated by the intercepted request;
receiving, by the client device, the image of the application from the remote computing device; and
rendering, by the client device, the at least one image of the application within the tab of the web browser based on the determined identifier.

2. The method of claim 1, wherein there is a plurality of applications or web pages hosted by the remote computing device in a plurality of web browser tabs, each associated with a respective identifier for the tab and respective images are displayed on each of the respective web browser tabs associated with respective identifiers.

3. The method of claim 2, wherein the respective images are received from a plurality of tabs hosted by the remote computing device and one of the plurality of tabs from the remote computing device is active and another of the plurality of tabs from the remote computing device is inactive.

4. The method of claim 1, further comprising:
receiving, by a native process running on the client device, the identifier for the tab of the web browser;
accessing, by the native process using the request, the remote computing session consequent to receiving the identifier for the tab of the web browser;
receiving, by the native process, the image of the application from the remote computing device;
sending, by the native process, the image of the application to the web browser along with the identifier for the tab of the web browser.

5. The method of claim 4, wherein the image of the application to the web browser is received by the native process via a virtual channel.

6. The method of claim 1, wherein the client device intercepts inputs from a peripheral input device and redirects them to the remote session.

7. The method of claim 1, wherein the client device uses a browser extension to intercept the request to launch the application hosted by the remote computing device.

8. The method of claim 1, wherein the client device uses an HTML5 client to intercept the request to launch the application hosted by the remote computing device.

9. The method of claim 1, wherein a browser native protocol of the web browser has been extended to enable the sending of the identifier and the request to the remote session.

10. The method of claim 1, wherein the image of the application to the web browser is displayed by painting the image on a canvas of the tab associated with the identifier.

11. A computing device comprising:
one or more processors; and
memory storing instructions that, when executed by the one or more processors, cause the computing device to:
access a remote computing session with use of a web browser executable on the computing device, the remote computing session configured to provide the computing device with access to applications hosted by a remote computing device;
intercept a request to launch an application hosted by the remote computing device;
determine an identifier for a tab of the web browser on which to render at least one image of the application indicated by the intercepted request;
receive the image of the application from the remote computing device; and
render the at least one image of the application within the tab of the web browser based on the determined identifier.

12. The computing device of claim 11, wherein there is a plurality of applications or web pages hosted by the remote computing device in a plurality of web browser tabs, each associated with a respective identifier for the tab and respective images are displayed on each of the respective web browser tabs associated with respective identifiers.

13. The computing device of claim 12, wherein the respective images are received from a plurality of tabs hosted by the remote computing device and one of the plurality of tabs from the remote computing device is active and another of the plurality of tabs from the remote computing device is inactive.

14. The computing device of claim 11, the memory further storing instructions that when executed by the one or more processors, cause the computing device to:
receive, by a native process running on the computing device, the identifier for the tab of the web browser;
access, by the native process using the request, the remote computing session consequent to receiving the identifier for the tab of the web browser;
receive, by the native process, the image of the application from the remote computing device;
send, by the native process, the image of the application to the web browser along with the identifier for the tab of the web browser.

15. The computing device of claim 14, wherein the image of the application to the web browser is received by the native process via a virtual channel.

16. The computing device of claim 11, wherein the computing device intercepts inputs from a peripheral input device and redirects them to the remote session.

17. The computing device of claim 11, wherein the computing device uses a browser extension to intercept the request to launch the application hosted by the remote computing device.

18. The computing device of claim 11, wherein the computing device uses an HTML5 client to intercept the request to launch the application hosted by the remote computing device.

19. The computing device of claim 11, wherein a browser native protocol of the web browser has been extended to enable the sending of the identifier and the request to the remote session.

20. One or more non-transitory computer-readable media storing instructions that, when executed, cause a computing device to:
access a remote computing session with use of a web browser executable on the computing device, the remote computing session configured to provide the computing device with access to applications hosted by a remote computing device;
intercept a request to launch an application hosted by the remote computing device;
determine an identifier for a tab of the web browser on which to render at least one image of the application indicated by the intercepted request;
receive, by a native process running on the computing device, the identifier for the tab of the web browser;
access, by the native process using the request, the remote computing session consequent to receiving the identifier for the tab of the web browser;
receive, by the native process, the image of the application from the remote computing device; and
render the at least one image of the application within the tab of the web browser based on the determined identifier.
